(19) United States
(12) Patent Application Publication
(10) Pub. No.: US 2007/0005333 A1
(43) Pub. Date: Jan. 4, 2007

(54) Analog tape emulation

(76) Inventors: Benard Setiohardjo, Orange, CA (US); Yu-Che Huang, Irvine, CA (US)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(21) Appl. No.: 11/173,022

(22) Filed: Jun. 30, 2005

(51) Int. Cl. G06F 9/455

(52) U.S. Cl. 703/24

(57) ABSTRACT

The present invention relates to a digital video recording system for use on an aircraft. The digital video recording system is configured with the same form factor as an analog video recording system to enable a direct hardware replacement. In addition the digital video recording system in accordance with the present invention is configured to emulate all of the functions of an analog video recording system including the ability to overwrite the existing data. By emulating the functions of an analog video recording system, aircraft which include cockpit controls for an analog video recording system can be reused with the newer digital video recording system. As such replacement of analog video recording systems is virtually seamless and does not require pilot training.

### COMPUTER PROGRAM LISTING APPENDIX

The present application includes a computer program listing included on a compact disc, hereby incorporated by reference.

### BACKGROUND OF THE INVENTION

1. Field of Invention

The present invention relates to a digital video recorder for an aircraft and more particular to a digital video recorder that emulates all of the functionality of an analog video recorder to enable seamless replacement of existing analog video recorders on aircraft with newer digital video recorders.

2. Description of the Prior Art

Aircraft video recording systems are generally known in the art. For example, Japanese Patent No. JP 52-039299, assigned to TEAC Corporation, discloses a video tape recording system which includes a video camera, a video tape recorder and a switch for operating the system. The system disclosed in the aforementioned Japanese patent was known to be used primarily during takeoff and landings of the aircraft. The idea behind such a video recording system was the belief that most aircraft accidents occur during takeoff and landing. By recording these events, investigation of a crash of the aircraft later was thought to be greatly facilitated.

Aircraft video recorders are known to be used for other purposes as well. For example, U.S. Pat. No. 6,366,311 and U.S. Patent Published Application Publication No. US 2002/0004695 A1, disclosed video systems for recording in events on board an aircraft. More particularly, these video systems were configured to be used to monitor events in the cockpit as well as the passenger compartment of an aircraft.

Video recording systems are also known to be used in strategic military applications. For example, such video recorders are known to be used in reconnaissance missions for identifying potential ground targets. In addition, aircraft video recorders are also known to be used to record the results of bombing missions.

In military applications, a video camera is located on the underside of the aircraft. The video recording system is located in an avionics bay aboard the aircraft. Controls for the video recording system are located in the cockpit to enable the system to be operated by the pilot. In addition to the standard controls for an analog video recording system, such as., record, rewind, play, etc., an event button is known to be included in the cockpit. The event button enables the pilot to mark certain events. For example, during bombing missions, pilots are known to activate the event button, which is recorded along with the video data. On playback, a signal, such as, an aural signal, is generated during playback to mark the event.

Both analog and digital aircraft video recording systems are known. Analog type video recording systems record video data on a magnetic tape, such as a 8 MM cassette tape. An example of such an analog video recording system is a Model No. V-88-B-M, as manufactured by TEAC Aerospace Technologies, LLC of Montebello, Calif. The 8 MM video tapes used with such systems normally provide about 120 minutes of playing time and are configured with a format that enables the tapes to be played on conventional ground playback equipment.

Newer aircraft are equipped with digital video recording systems. An example of a digital video recording system is a Model No. MDR-80, as manufactured by TEAC Aerospace Technologies, LLC. The MDR-80 digital recording system includes a removable memory unit with about 24 GB of memory.

In order to conserve memory space in such video recording systems, the video data is compressed to meet various compression standards, such as the MPEG-2 standard. The MPEG-2 standard is a compression standard for video data by the Motion Picture Experts Group. MPEG-2 standard and applies to both video and audio data. In general, both analog audio and video data is received by an analog to digital converter and converted to digital signals. The digital signals are encoded (i.e., compressed) in MPEG-2 protocol and packetized by an MPEG-2 coder-decoder (codec). The MPEG-2 video and audio data is stored for later playback in MPEG-2 format.

The standards which cover the MPEG-2 compression protocol are available at http:\www.chiarigilione.org\mpeg\. Various systems are known for encoding video and audio data in MPEG-2 protocol. Examples of such systems are disclosed in U.S. Pat. Nos. 5,521,927; 5,682,204; 5,878,166 and 6,459,850, as well as U.S. Patent Application Publication Nos. US 2001/0000704 A1; US 2002/0012530 A1; US 2002/0057902 A1 and US 2003/0103765 A1.

There is a need to replace analog video recording systems in older aircraft with newer digital video recorders which record and store the video data on a removable electronic memory. Unfortunately, older aircraft that are equipped with older analog video data recorders are configured with controls in the cockpit for operating such analog video recorders. Such controls are used to provide standard analog video recorder functions such as: record, rewind, play, stop, fast forward and pause.

Unfortunately many of the analog tape functions have no corresponding applicability to digital video recorders. In addition, such analog video recording systems are also known as to have the ability to tape over existing data. The MPEG-2 format does not allow overwriting existing data. Thus, in order to update aircraft with older analog video recording systems, it is necessary to replace the cockpit controls as well. Updating the cockpit controls is relatively expensive and requires retraining of the pilot and is thus a very costly and expensive undertaking. Thus, there is a need to enable updating older analog video recording systems with newer digital video recording systems without the need to replace the cockpit control or require recertification or retraining of pilots.

### SUMMARY OF THE INVENTION

The present invention relates to a digital video recording system for use on an aircraft. The digital video recording system is configured with the same form factor as an analog video recorder system to enable a direct hardware replacement. In addition, the digital video recording system in accordance with the present invention is configured to emulate all of the functions of an analog video recording system including the ability to overwrite existing data. By emulating the functions of an analog video recording system, aircraft which include cockpit controls for an analog video recording system can be reused with a newer digital video recording system. As such replacement of analog video recording systems is virtually seamless and does not require recertification or pilot training.

### DESCRIPTION OF THE DRAWING

These and other advantages of the present invention will be readily understood from the following specification and attached drawing wherein:

FIG. 1A is a simplified block diagram of a digital video recording system for use with the present invention.

FIG. 1B is a simplified block diagram of a digital playback system for use with the present invention.

FIG. 2 is a data flow diagram illustrating the data flow in the recording mode of the system in accordance with the present invention . . .

FIG. 3A is a graphical illustration of a exemplary group of pictures (GOP) in accordance with the MPEG-2 standard.

FIGS. 3B-3D illustrate the uniform GOP size of three exemplary GOPs in accordance with an important aspect of the invention.

FIG. 4 is a timeline diagram illustrating the temporal distribution of GOPs in an exemplary system.

FIG. 5 is a flow chart illustrating the response of the system to a start record command.

FIG. 6 is a flow chart tape illustrating the handling of MPEG-2 data received during recording.

FIG. 7 is a flow chart illustrating the handling of MPEG-2 frame index data received during recording.

FIG. 8 is a flowchart illustrating the response of the system to a stop recording command.

FIG. 9 is a flowchart illustrating the processing of frame index data.

FIG. 10A is a flow chart illustrating the method for determining the initial tape position in a playback mode.

FIG. 10B is a flow chart illustrating the method for keeping track of the tape head position during a playback mode.

FIG. 10C is a flowchart illustrating the initialization of a playback engine.

FIG. 11 is a flowchart illustrating the emulation of an analog play function

FIG. 12 is a flowchart illustrating the emulation of an analog stop function.

FIG. 13 is a flowchart illustrating the emulation of an analog pause function.

FIG. 14 is a flowchart illustrating the emulation of an analog scan forward function.

FIG. 15 is a flowchart illustrating the emulation of an analog scan reverse function.

FIG. 16 is a flowchart illustrating the emulation of an analog fast forward function.

FIG. 17 is a flowchart illustrating the emulation of an analog rewind function.

FIG. 18 is a flow chart illustrating the emulation of an analog multi-speed playback (forward and reverse) function.

### DETAILED DESCRIPTION

The present invention relates to a digital video recording system for use on-board an aircraft. In accordance with an important aspect of the invention, the digital video recording system is adapted to be used on board aircraft as a replacement for analog video recording systems that include cockpit controls. More particularly, the present invention is a digital video recording system that is configured to emulate all of the standard functions of an analog video recording system such as: record, play, stop, rewind, fast forward and pause as well as provides the ability to overwrite stored data. In order to simplify replacement of older analog video recording systems, the digital video recording system in accordance with the present invention is configured with the same form factor as an analog video recording system. As such, the digital video recording system can be used to replace the analog video recording system in the avionics cabinet of the aircraft with no modification. Moreover, since the digital video recording system emulates all of the functionality of an analog video recording system, the existing cockpit controls can be used to control the digital video recording system as well. As such, replacement of an existing analog video recorder system with digital video recording system in accordance with the present invention is virtually seamless and obviates the need for pilot retraining.

The digital video recording system, in accordance with the present invention, is configured to encode digitized video as well as audio data with a standard compression protocol, such as MPEG-2. As will be discussed in more detail below, the digital video recording system utilizes standard hardware, such as an off-the-shelf coder-decoder (codec) to encode and decode the digitized audio and video data, for example, in MPEG-2 format. Since the MPEG-2 format does not allow for various functions available on analog video recorders, the MPEG-2 encoded data is processed to provide additional functionality before the data is stored. As such, the data manipulations are virtually transparent on playback and thus can be played back on a standard digital playback device.

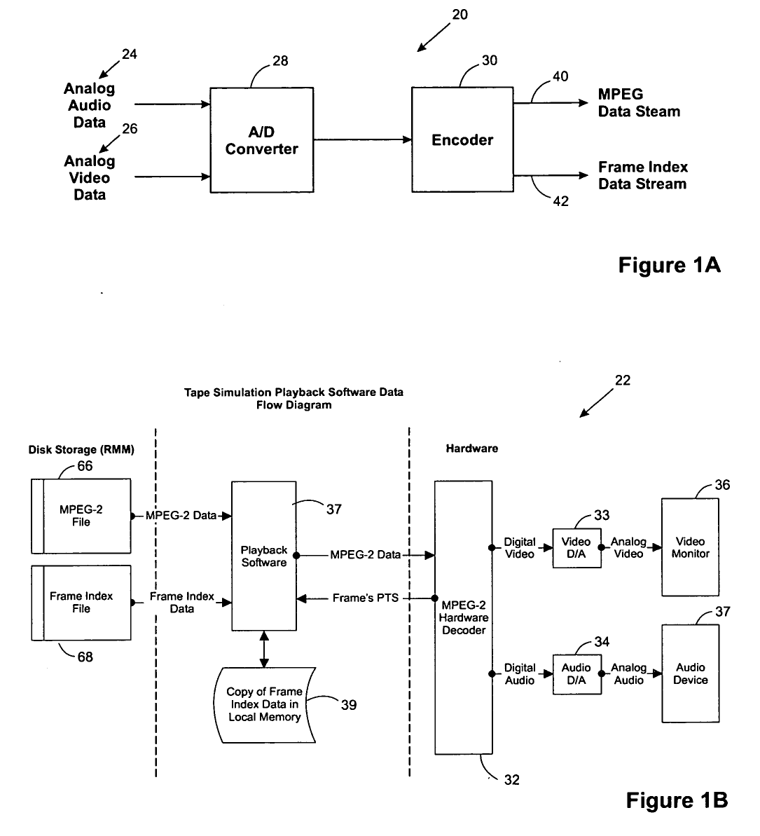

FIG. 1A illustrates an exemplary recording system hardware 20 for use with the present invention, while FIG. 1B illustrates an exemplary playback system 22. The encoder 20 receives analog audio data 24, from a microphone (not shown), as well analog video data 26 in either NTSC or PAL format, from a video camera (not shown). Both the analog audio data 24 and the analog video data 26 are applied to an analog to digital converter 28 for example, a Phillips Model No. 7115. The analog to digital converter 28 digitizes the analog audio data 24 and video data 26 and applies it to an encoder 30. The encoder 30 compresses the analog audio data 24 and analog video data 26 in accordance with a compression format, such as MPEG-2. The encoder 30 converts the input data into a MPEG data stream and a frame index data stream. As will be discussed in more detail below, the MPEG data stream, as well as the frame index data stream, are processed by the recording software in accordance with one aspect of the present invention and stored as a compressed video file; an MPEG-2 file and a frame index file.

The playback system 22 includes a decoder 32, which may include a video digital to analog (D/A) converter 33 for playback of analog video on a conventional analog video monitor 36 and an audio D/A converter 34 for playback of analog audio by way of conventional analog audio playback device 37. Alternatively, the decoder 32 may be provided without a D/A converter for playback on conventional digital playback devices. The compressed MPEG-2 file, as well as the frame index file, are received by the playback software 37. As will be discussed in more detail below, the playback software system 37 uses the frame index data during the playback process to locate (position) and scan the MPEG-2 data. The MPEG-2 output by the playback software 37 is applied to the decoder 32, which decompresses and decodes the data. The decompressed data, available at the output of the decoder 32, is applied to a conventional playback device 36.

The Frame Index data from the Frame Index File 68 is stored in local memory 39. As will be discussed in more detail below, the frame index data facilitates playback.

An important aspect of the invention relates to the fact that the system emulates the head position of an analog tape recording device. As such, the system keeps track of the head position in both a playback mode and a recording mode. The playback software 37 utilizes the PTS from the decoder 32 to determine the tape head position in the playback mode, as will be discussed in more detail below.

The encoder 30 and decoder 32 may be provided by a single encoder-decoder (codec) integrated circuit. An exemplary MPEG-2 codec is a Conexant Model No. CX23415, available from Conexant Systems, Inc. in Newport Beach, Calif. Other codecs are suitable for use with the present invention as well.

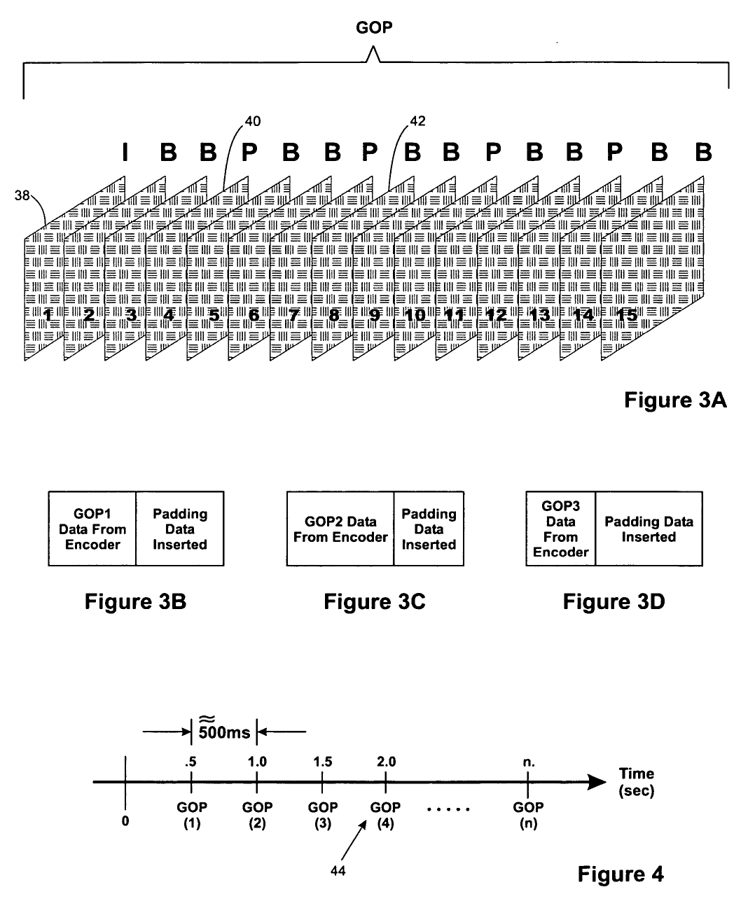

Before getting into the present invention, a short description of the MPEG-2 encoding format is provided and illustrated in FIGS. 3 and 4. A standard NTSC analog video signal is approximately 30 frames per second. The MPEG-2 format configures these analog video frames into a sequence of three types of frame, identified as I-frames 38, P-frames 40 and B-frames 42. Generally speaking, the MPEG-2 encoding system is based on the premise that the video frames do not change much from frame to frame.

An I-frame 38 is an intra-coded frame or reference frame which can be reconstructed without reference to any other frame. A P-frame 40 is a forward predicted frame from the last I-frame 38 or P-frame 40. It is generally impossible to reconstruct a P-frame 40 without data of an I-frame 38 or a P-frame 40. B-frames 42 are both forward predicted and backward predicted from the last or next I-frame 38 or P-frame 40.

Each of the frames illustrated in FIG. 3 represents a single encoded frame of an NTSC video signal. In accordance with MPEG-2 protocol, the encoded frames are grouped in GOPs (groups of frames). The number of video frames per GOP is constant for each MPEG-2 recording session. However, the amount of data stored for each frame varies, which, in turn, causes the amount of data per GOP to vary for several reasons. First, the size of the frame data is dependent on the MPEG-2 parameters used for the recording. For example, recording at a higher bit rate will result in a larger amount of frame data. Secondly, even with the same set of parameters, the frame data sizes will vary depending on the video frames being recorded. In particular, the MPEG-2 compression algorithm takes into account the differences in consecutive frames. For example, video segments that contain fast moving objects will require more data to encode compared to a video segment with still images.

In accordance with an important aspect of the invention, the GOP size (i.e. the amount of data stored per GOP) and the MPEG-2 parameters are kept constant, as illustrated in FIGS. 3B-3D. The fixed GOP size is determined to be large enough to contain encoded data recorded from a complex video segment. The remaining memory locations for each GOP that are not used are filled with encoded video data are filled with MPEG-2 padding stream data.

For discussion purposes, each GOP is illustrated with an exemplary number of frames, for example, 15 frames. Each frame of NTSC video data is approximately 33.333 milliseconds. Thus, an exemplary GOP with 15 frames is approximately 500 milliseconds in length, as shown in FIG. 4. Since the number of frames per GOP is fixed, the elapsed time per GOP is known. As such, the system in accordance with the present invention can emulate the head position of an analog video recording system in terms of GOPs and thus emulate the standard functions associated therewith by keeping track of the time in both the record and playback modes.

Each frame is identified by various parameters including a presentation time stamp (PTS) is a temporal offset from the beginning of the recording system and a byte offset. The PTS is used for synchronizing the audio and video data during playback. In particular, an MPEG-2 data stream includes a Video Elementary stream and an Audio Elementary stream. Each stream is decoded separately. The decoder uses the PTS to determine when the data is to be rendered. Without the PTS, the video and audio data would be out of sync. The byte offset of a frame refers to the offset from the beginning of the file in bytes where the data for the specific frame starts.

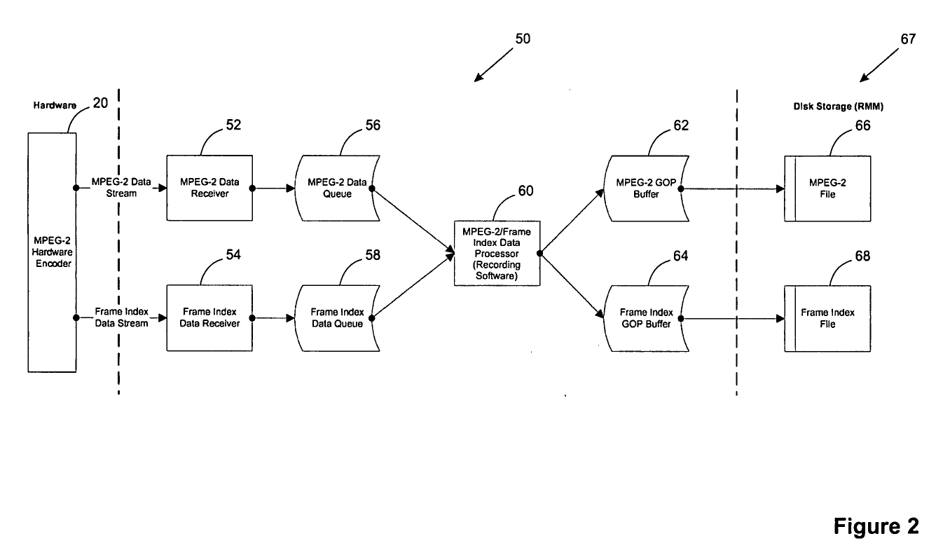

FIG. 2 is a data flow diagram of the tape emulation system 50 in accordance with the present invention during a record mode. After recording is commenced (i.e., a record command is received), the encoder 20 will send streaming MPEG-2 data 40 and frame index data 42. to a local MPEG-2 data buffer 52 and a frame data buffer 54, respectively. The MPEG-2 data buffer 52 and frame index data buffer 54 are used to store the MPEG-2 data stream and frame index data stream in real time. Data from the MPEG-2 data buffer 52 is transferred to a MPEG-2 data queue 56. Similarly, frame index data from the frame index data buffer 54 is transferred to a frame index data queue 58. The MPEG-2 data and frame index data from the MPEG-2 data queue 56 and frame index data queue 58 are processed by an MPEG-2/frame index data processor 60 (also referred to as “recording software”), as will be discussed in more detail below. The MPEG-2/frame index data processor 60 manipulates the MPEG-2 data as well as the frame index data so as to emulate the functionality of analog video recorder.

The recording software 60 processes one frame at a time. Each frame that is processed is temporarily stored in a MPEG-2 GOP buffer 62 and a frame index GOP buffer 64 until one GOP of frames has been processed. Once a GOP of frames has been processed, the MPEG-2 data is written to a MPEG-2 file 66 in a removable memory storage device 67. Similarly, the frame index data from the frame index GOP buffer 64 is written to a framed index file 68 in the removable memory storage device 68.

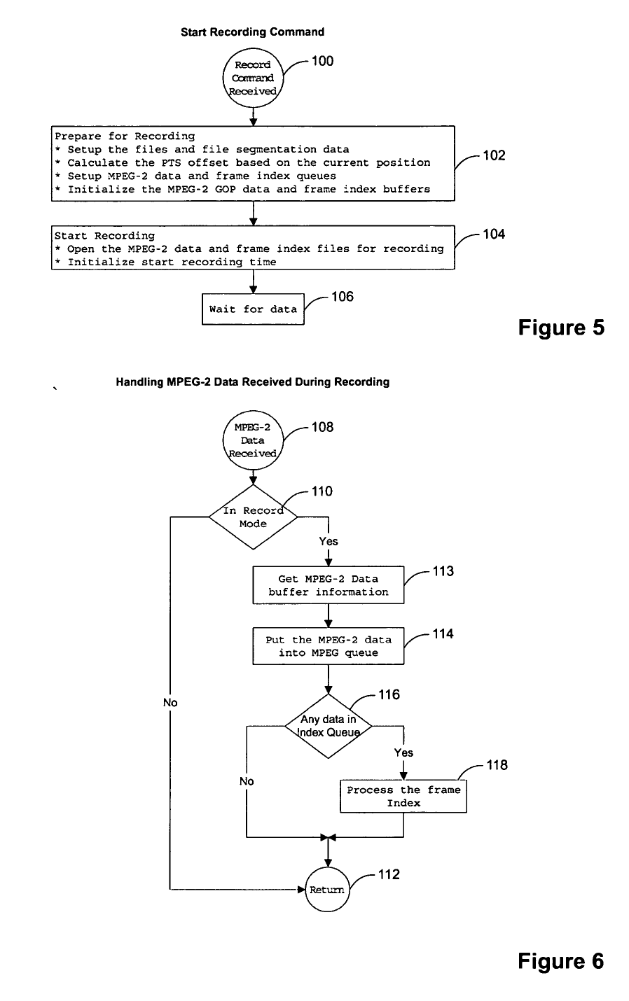

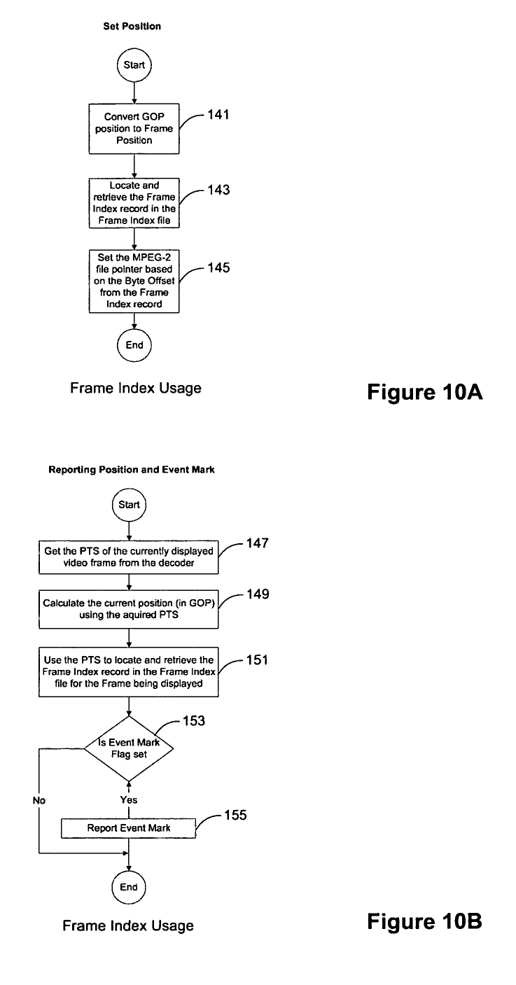

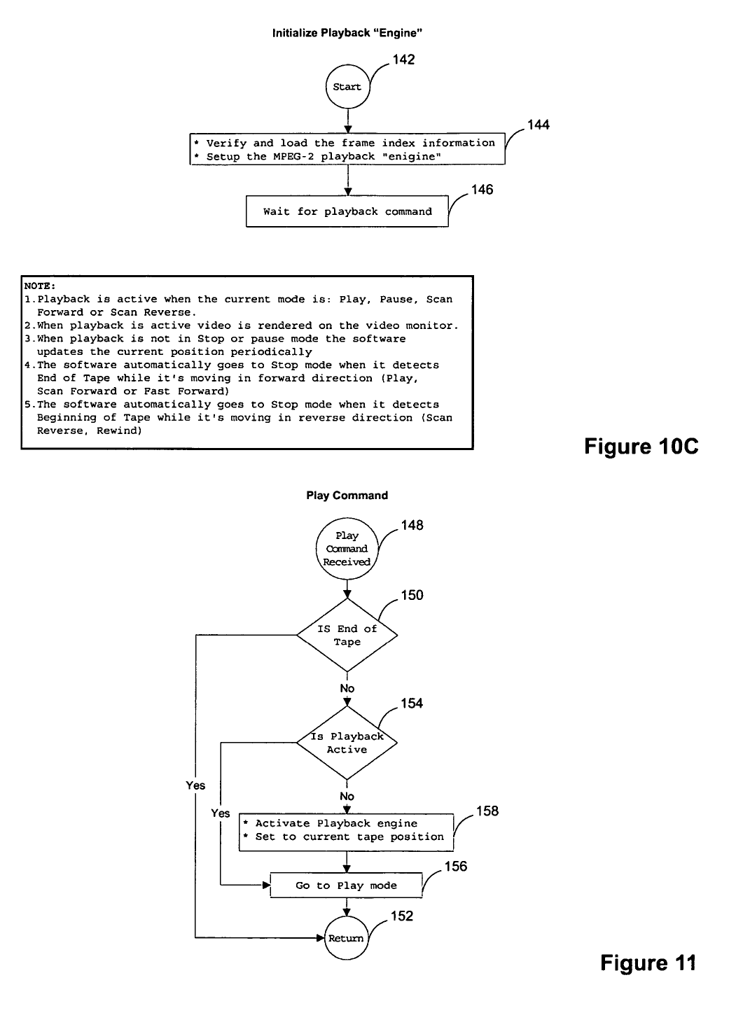

FIGS. 5-17 illustrate the emulation of various analog tape functions in accordance with the present invention. In particular, FIGS. 5-9 illustrate the emulation of an analog recording function as well as the operation of the recording software 60 and specifically how the MPEG-2 data stream and frame index data stream from the MPEG-2 hardware encoder 20 is processed and stored in a, for example, removable memory device 67, as MPEG-2 files 66 and frame index file 68. As mentioned above the MPEG-2 file 66 is configured for playback on a conventional playback device 36. The frame index file 68 is used by the operating system of playback device 36 to search and locate MPEG-2 video data. FIGS. 10-17 illustrate the emulation of various analog tape playback functions.

Referring to FIG. 5, the digital video recording system in accordance with the present invention is configured to be controlled with conventional controls for an analog video tape recording system. FIG. 5 is a flow chart illustrating the response to a record command. As indicated in step 100, the recording software 60 prepares for recording in step 102 by initializing the system. In particular, the MPEG-2 file 66 and frame index file 68 (FIG. 2) are set up in addition in a file segmentation for the MPEG-2 files is also set up. File segmentation does not form any part of the present invention and is described in detail in co-pending application Ser. No. 10/153,116 filed on May 22, 2002, published on Apr. 1, 2004 as U.S. Patent Application Publication No. US04/0062518 A1, assigned to the same assignee as the present invention, hereby incorporated by reference.

In preparation for recording, the system also determines the presentation time stamp (PTS) offset based on the current position. In particular, as discussed above, in accordance with the present invention, the number of frames in a GOP is standardized, for example, 15 frames per GOP. As such, in response to a record command, the system determines the PTS offset (i.e.) number of frames from the beginning of the MPEG-2 data file 66 (FIG. 2) relative to the current position. If the system is in a playback mode, a record command can occur during any frame of a GOP. Assuming that the record command is received during a playback mode at frame 5 (FIG. 3) of a GOP 44 (FIG. 4), the system determines the offset or number of frames from the beginning of the MPEG-2 data file 66 (FIG. 2) to the first I-frame 38 (FIG. 3) in the GOP 44 (FIG. 4). The new data will overwrite the existing data starting with GOP 44.

For NTSC analog video data, each frame is approximately 1/30 of a second. With reference to FIG. 4 each GOP represents approximately 500 milliseconds. As such, the presentation time stamp represents the temporal position of a specific GOP within the sequence of GOPs, as indicated in FIG. 4. In other words, as shown, GOP₍₃₎ is presented at roughly 1.5 milliseconds from the beginning of the recording session.

Each frame in the MPEG-2 data file 66 (FIG. 2) has a corresponding frame index record in the Frame Index File 68. The order of the Frame Index record in the Frame Index file is the same as the order of the frame indexed in the MPEG-2 file. For example, the frame Index record number 200 in the Frame Index file may be used to index frame number 200 in the MPEG-2 file.

The frame index record contains various data for each frame. as illustrated in Table 1 below.

TABLE 1

| Field in Frame | |
|---|---|
| Index Record | Description |
| Frame Size | Size of the indexed frame in bytes |
| Byte Offset | Offset (in bytes) from the beginning |
| | of the MPEG-2 file where the data of |
| | indexed frame starts |
| Frame Type | Type of indexed frame, I, B or P |
| PTS | PTS of the indexed frame |
| Date/Time Stamp | Date and time when the indexed frame |
| | was recorded |
| Event Mark Flag | A flag indicating whether event mark |
| | was active when the indexed frame was |
| | recorded |

Except for the date/time stamp and the event mark flag, in one embodiment of the invention, the rest of the parameters in Table 1 are generated by the encoder 30 (FIG. 1A). In particular, the encoder 30 sends the data in separate streams to the first four fields in Table 1. The recording software 60 (FIG. 2) receives the frame index record from the Frame Index Data Queue 58 and adds the two fields, Date/Time Stamp and Event Mark Flag, during processing of the MPEG-2 and Frame Index data and stores the data into the Frame Index File 68. As mentioned above, the event mark flag is responsive to a manual switch in the cockpit that the pilot can use to mark events of interest during playback.

The modified Frame Index data provides many benefits as follows:
It allows the playback software 37 (FIG. 1B) to quickly position or locate a frame within the MPEG-2 file. Because the index file is much smaller than the MPEG-2 file, searching for a specific frame can be done a lot faster by searching the Frame Index file than searching the MPEG-2 data itself.
It allows more efficient implementation of multi-speed playback (Scan Forward/Reverse). During multi-speed playback, the software skips frames and locates the next video frame to be displayed. Without the Frame Index file, the software would have to perform a time consuming scan through the MPEG-2 file to locate the next frame. This task may not be completed in a timely manner in a low performance system.
It allows detection of an event mark during PLAY and SCAN modes. The playback software 37 can quickly search the Frame Index record in the Frame Index file for the frame being rendered and find out if event mark was active when the corresponding frame was recorded.

Referring back to FIG. 5, in addition to forming the frame index file, the recording software 60 (FIG. 2) also initializes the MPEG-2 data queue 56 (FIG. 2) and frame index data queue 58. Similarly, the MPEG-2 GOP buffer 62 as well as the frame index GOP buffer 64 are also initialized.

After the initialization of step 102, the system begins recording in step 104. In step 104, the system obtains permission from the operating system to allow data to be written into the MPEG-2 file 66 (FIG. 2) as well as the frame index file 68. In addition to configuring the MPEG-2 data buffer 52 and frame index data buffer 52, a start recording timer is initialized. As mentioned above, an important aspect of the invention is that an analog tape head is emulated by keeping track of the time in both a record mode and a playback mode. Since each GOP is approximately 500 milliseconds, the system is able to keep track of the GOPs by keeping track of the recording time. After the start recording timer is initialized, the system is ready to receive video data as indicated in step 106.

FIG. 6 illustrates how MPEG-2 data is handled when the system is in a record mode, as indicated in step 108. Initially, in step 110, the system detects whether it is in the record mode by checking to see if the record button (not shown) has been depressed. If not, the system returns to step 112. If the system is in a record mode, the system reads the video data in the MPEG-2 data buffer 52 in step 113. The data from the MPEG-2 data buffer 52 is then written to the MPEG-2 data queue 56 in step 114. After the MPEG-2 data is written to the MPEG-2 data queue 56, the system checks in 116 for the frame index data for the frame being processed to determine if it contains any data. If so, the system processes the data in step 118 and returns to step 112. If there is no frame index data in the frame index data queue 58, the system returns to step 112

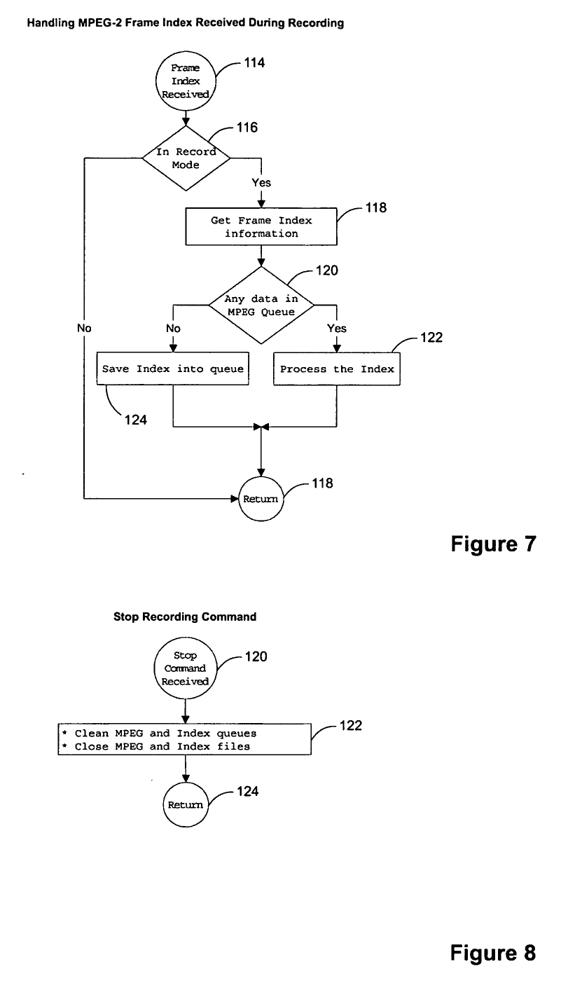

FIG. 7 is a flow diagram illustrating how MPEG-2 frame index information is handled during a record mode. As mentioned above, the MPEG-2 hardware and encoder 20 outputs a frame index data stream, as indicated in step 114. Initially in step 116, the system determines if it is in a record mode. If not, the system returns to step 118. If the system is in a record mode, the system receives the frame index information in a frame index data buffer 54 in step 118. The system then checks in step 120 to determine whether there is any index data in the frame index queue 58. If so, the system processes the index in step 122, as will be discussed in more detail below. If there is no existing data in the frame index data queue 58, the system saves the frame index data into the frame index data queue 58 in step 124 and returns in step 118.

FIG. 8 is a flow chart illustrating the emulation of an analog stop function. In particular, when a stop command is detected after a record command, as indicated in step 120, the system initializes the MPEG-2 data queue 56, as well as the frame index data queue 58 as well as commands the operating system to close assess to these files in step 124.

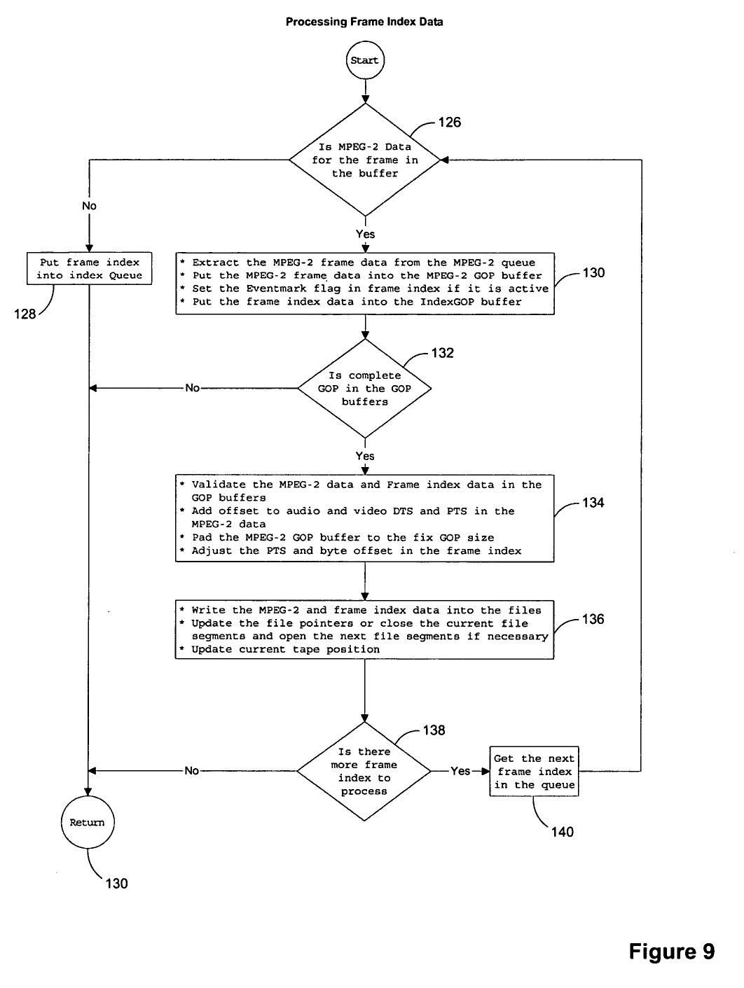

FIG. 9 is flow chart illustrating how the recording software processes frame index data. As mentioned, a frame index data stream from the MPEG-2 hardware encoder 20 (FIG. 2) is applied to a frame index data buffer 54. In response to a record command, the recording software 60 checks in step 126 whether there is any MPEG-2 data for the current frame in the MPEG 2 data buffer 52. If not, the current frame index data stream for the current frame is written to the frame index data 258 in step 128 and the recording software 60 returns to step 130. If it is determined in step 126 that there is MPEG-2 data currently in the MPEG-2 data buffer 52, the current MPEG-2 frame data is read from the MPEG-2 data queue 56. The system processes one frame at a time. As indicated in step 130, the MPEG-2 data as well as the frame index data from the MPEG-2 data queue 56 and the frame index data queue 58 are written to the MPEG-2 GOP buffer 62 and frame index GOP buffer 64 until an entire GOP (i.e. 15 frames) has been processed. As such, in step 132, the system determines if an entire GOP has been written to the MPEG-2 GOP buffer 62 and the frame index GOP buffer 64. If not, the system returns to step 130. If so, the system processes the MPEG-2 data and frame index data in the MPEG-2 GOP buffer 62 and frame index GOP buffer 64. Specifically, the MPEG-2 data in the MPEG-2 GOP buffer 62 as well as the frame index data in the frame index GOP buffer 64 is validated. The system validates the GOP data in the MPEG-2 GOP buffer 62 (FIG. 2) and the Frame Index GOP buffer 64 by checking if there are 15 frames in the buffers 66 and 68 and that the frame type and sequence are correct (i.e. IBBPBBP . . . ). In addition, an offset is added to the DTS and PTS in the MPEG-2 data.

DTS stands for Decoding Time Stamp. PTS indicates when the video or audio frame to be presented and DTS indicates when the video or audio frame is to be decoded. These offsets relate to the difference in time from the beginning of the MPEG-2 file 66 (FIG. 2) to the I-frame in the GOP where the record command was received. More particularly, the MPEG-2 encoder 30 (FIG. 1) resets PTS and DTS every time a new recording is commanded. The MPEG-2/Frame Index Data Processor 60 (FIG. 2) adjusts the DTS and PTS in the MPEG-2 data and Frame Index data by adding the offset to make the newly recorded data look like it was part of original MPEG-2 file 66. For example, if a new recording is started to overwrite GOP 44 (e.g. at a time offset of 2 seconds), the new recording data will have the PTS representing time of 0 seconds. By adding the 2 seconds offset, the new recorded data will look like if it was part of the original data starting from the existing GOP 0.

As mentioned above, the tape emulation system in accordance with the present invention is based on the fundamental concept that all GOPs in the MPEG-2 data file 66 have the same number of frames, for example 15, and have the same size. The GOP size is defined to be a size large enough to accommodate the largest GOP data. In some cases, the actual data recorded in a GOP may be smaller than the defined GOP size. In those cases the remaining locations in the GOP buffer that are not used to store the recorded data are filled with padding data. The padding data (padding stream) is a valid standard MPEG-2 data which is discarded during playback.

As mentioned above, all GOPs are fixed in size and the number of frames, such as 15 frames per GOP. As such, some of the data in a GOP is dummy data. This dummy data within the GOP is identified in step 134 in order to simplify processing during playback. The presentation time stamp and byte offset are adjusted in the current frame index . . .

Subsequently, in step 136, the MPEG-2 data from the MPEG-2 GOP buffer 62 and the frame index data from the frame index GOP buffer 64 are written to the MPEG-2 file 66 and frame index file 68, respectively. The recording software 60 then updates the file pointers to point to the MPEG-2 data buffer 52 and frame index buffer 54. In addition, the current tape position is determined, for example, by measuring the record time.

In step 138 the system determines whether there is more index data to process. If not, the system returns to step 130. If so, the system reads the next frame index data from the frame index data queue 58 and returns to step 126.

FIGS. 10-17 illustrate the emulation of various playback functions. As used herein, playback mode is active when any of the following controls are activated: play, pause, scan forward or scan reverse. When the playback mode is active, video images are displayed by the playback devise 36 (FIG. 1B). In addition, when the playback is not in a stop or pause mode, the software may update the current position periodically. As mentioned above, the system emulates an analog video recording device which records video data on analog tape. As such, the software will automatically proceed to the stop mode when it detects and indicate while it is moving in a forward direction (i.e., play, scan forward or fast forward). Similarly, the software automatically goes to a stop mode when it detects the beginning of the tape while it is moving in a reverse direction (i.e., scan, reverse, rewind).

The recording software 60 (FIG. 2) as well as the playback software 37 (FIG. 1B) keep track of the emulated analog “Tape Head Position” at all times. When a Playback function (Play, Pause, Scan Forward or Scan Reverse) is selected by a user while playback is not active, the playback software 37 determines the initial “Tape Head Position.” In particular, the playback software 37 sets a file pointer in the MPEG-2 file to the beginning of the GOP (I-Frame) to start playing from, as indicated in FIG. 10A. The playback software 37 (FIG. 1B) converts the GOP number to frame number in step 141 by multiplying the GOP number by the number of frames per GOP. The result is multiplied with the size of the Frame Index record to locate the Frame Index record of the starting frame in the Frame Index file. Once the Frame Index record is located and retrieved, as indicated in step 143, the MPEG-2 file pointer is set in step 145 to the starting position of the frame using a Byte Offset value in the Frame Index record.

During a playback mode, the playback software 37 also keeps track of the Tape Head Position during playback. More particularly, while in a playback mode (Play, Scan Fwd and Scan Rev.), the playback software 37 keeps track of the current position and reports if the video frame being displayed was recorded while event mark was active. With reference to FIG. 10B, the playback software 37 gets the PTS of the currently displayed video frame from the decoder 32 (FIG. 1B) in step 147 and calculates the current position (in GOP) based on the PTS of the frame in step 149. The playback software 37 then searches the Frame Index record in the Frame Index file using the acquired PTS in step 151 and checks the Event Mark Flag in the Frame Index record in step 153. If the Event Mark flag is set, it is reported in step 155 and used to drive an aural or visual indicator.

Referring to FIG. 10C, a flow chart for initializing the playback mode is illustrated. Initially in step 142 a playback mode is initiated. In the playback mode, as indicated in step 144, the MPEG-2 files 166 are loaded into the playback device 36 for playback in step 144. The Frame Index File is loaded into local memory 37. The Frame Index File 68 allows the MPEG-2 data in the MPEG-2 file 66 to be quickly scanned and video data quickly located. The MPEG-2 playback mode is also set up. In step 146, the system waits for the playback command.

FIG. 11 is a flow chart illustrating the emulation of an analog play function. In particular, step 148 represents the receipt of a play command. Initially, in step 150 the system determines whether the playback command was received at a simulated end of the tape condition. As mentioned above, the tape length is equated to a GOP. Depending on the size of the removable memory unit, an end of tape is calculated to be equivalent to the number of MPEG-2 file 66 and frame index file 68 that can be loaded into the removable memory unit. In step 150, the system determines how many GOPs have been stored and whether a pseudo end of tape condition exists by determining the maximum number of GOPs. If so, the system returns to step 152. If not, the system goes to step 152 and determines if the playback mode is active. If so, the system goes to the playback mode in step 156. If not, the system activates the playback engine, as discussed above, and sets it to the current tape position instep 158.

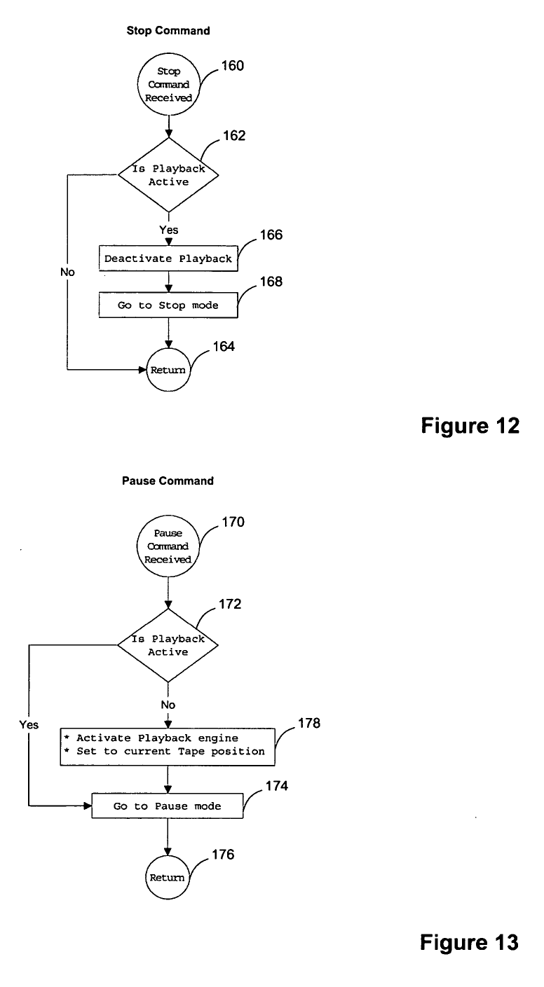

FIG. 12 is a flow chart illustrating the emulation of an analog a stop function. After a stop command is received, as indicated in step 160, the system determines if the playback mode is active in step 162. If not, the system returns to step 164. If the playback mode is active in step 162, the system deactivates the playback mode in step 166 and goes to the stop mode in step 168.

FIG. 13 is a flow chart illustrating the emulation of an analog stop function. After the stop command has been received, as indicated in step 170, the system determines if the playback mode is active in step 172. If so, the system goes to the pause mode in step 174 and returns in step 176. If the system is not in the playback mode, the system activates the playback engine in step 178 and sets the system to the current tape position.

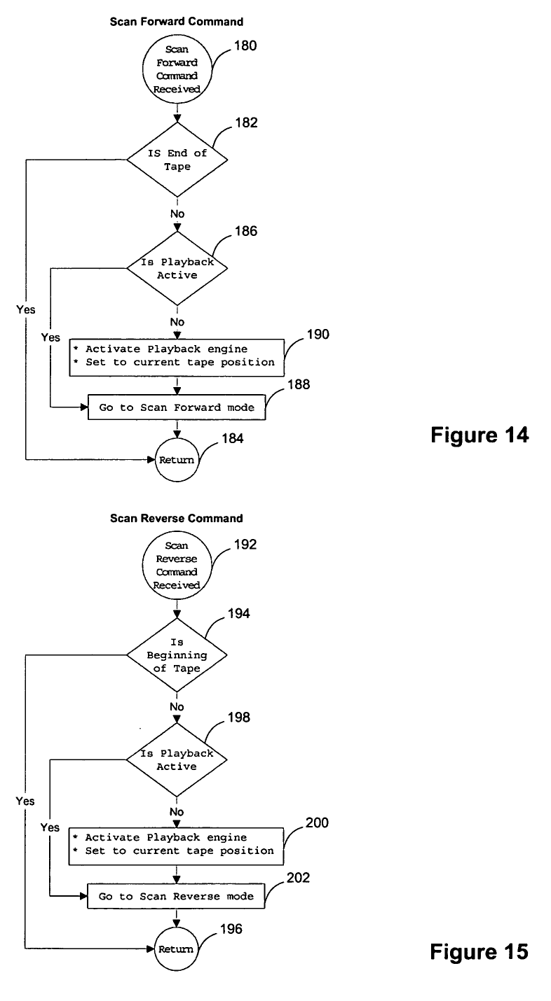

FIG. 14 is a flow chart illustrating the emulation of an analog scan forward command. Step 180 indicates that a scan forward command has been received. Initially, in step 182 the playback software 37 determines whether there is an end of tape condition, as discussed above. If so, the system returns to step 184. If not, the playback software 37 checks in step 186 whether the playback mode is active. If so, the playback software 37 goes to a scan forward mode in step 188. If the playback mode is not active, the system activates the playback engine in step 190 and sets the tape position to the current tape position.

FIG. 15 is a flow chart illustrating the emulation of an analog scan reverse function. Step 192 illustrates a scan reverse command received. Initially, in step 194 the system determines whether a beginning of tape condition exists. If so, the system returns to step 196. If not, the system goes to step 198 and determines whether the playback mode is active. If not, the system activates the playback engine in step 200 and sets the counter to the current tape position. If the playback system is active, the system goes to the scan reverse mode in step 202.

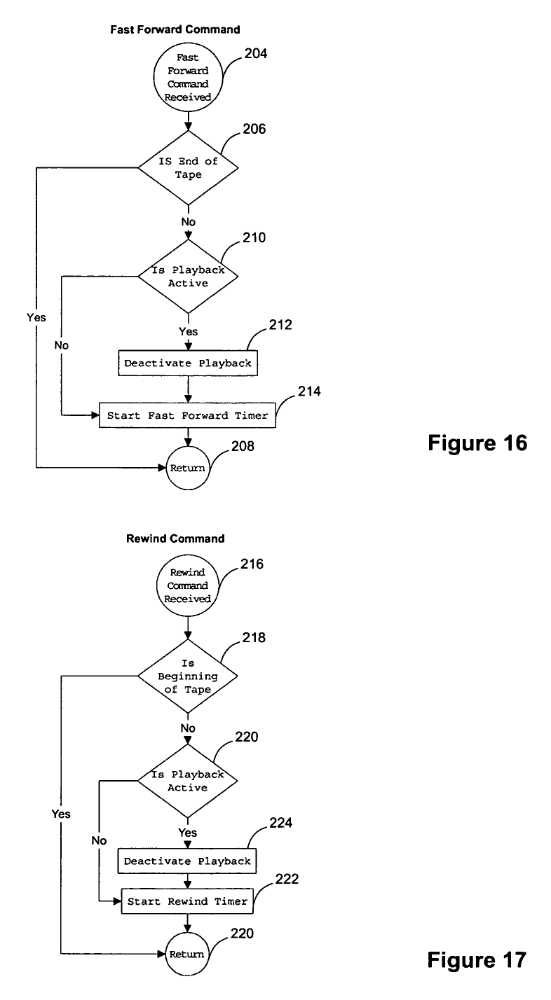

FIG. 16 is a flow chart illustrating the emulation of an analog fast forward function Step 204 illustrates that a fast forward command has been received. In step 206 the system first determines whether an end of tape condition exists. If so, the system returns to step 208. If not, the system goes to step 210 and determines if the playback mode is active. If so, the system deactivates the playback mode in step 212. If the play back mode is not active, the system starts the fast forward timer instead of 214. The system can emulate both forward and reverse commands including a fast forward command by simply measuring the time. The timer allows various fast forward and rewind speeds to be simulated, such as 30×. The fast forward timer will continue to be advanced until either the end of tape condition exists or the command is deactivated.

FIG. 17 is a flow chart illustrating the emulation of an analog rewind function. In step 216 indicates a receipt of a rewind command. Initially, in step 218 the system determines whether a beginning of tape condition exists. If so, the system returns to step 220 since the tape cannot be rewound any further than the beginning of a tape. As mentioned above, this corresponds to the GOPs at the beginning of the removable memory device. If a beginning of tape condition does not exist, the system then checks in step 220 to see if the play back mode is active. If so, the system initiates a rewind timer in step 222. The rewind timer basically decrements the current position timer until either the beginning of tape condition occurs or the rewind command is deactivated. The system then returns to step 220. On the other hand if the play back mode is active, the system deactivates the play black mode in step 224 and then initiates the rewind timer.

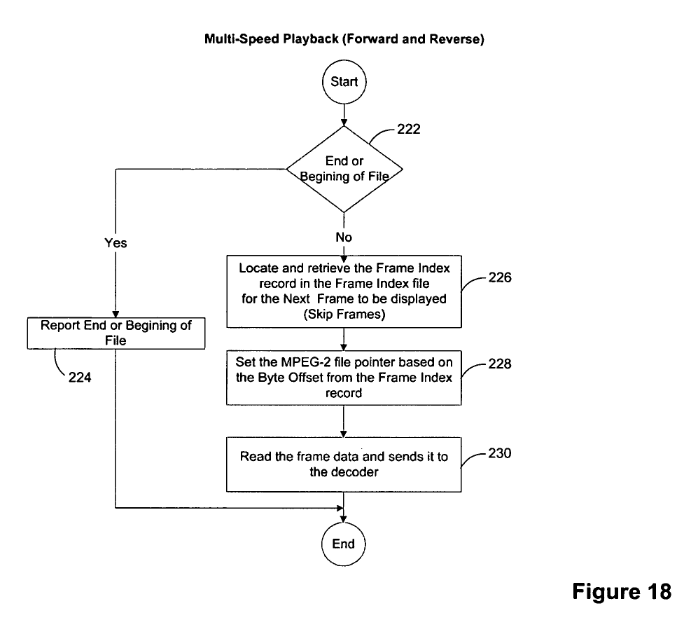

FIG. 18 is a flow chart illustrating the emulation of an analog multi-speed playback function. In a multi-peed playback mode, the playback software 37 first checks end or beginning of file condition in step 222. If either condition is detected, it is reported in step 224. If not, the playback software 37 skips frames and locates the next frame to be displayed in step 226. In step 228, the playback software 37 scans the index file to locate the Frame Index record for the next frame, set the MPEG-2 file pointer to the Byte Offset from the Frame Index record in step 228. In step 230, the playback software 37 reads the frame data and sends it to the decoder 32 (FIG. 1B).

Obviously, many modifications and varieties of the present invention are possible in light of the above teachings. Thus, it is to be understood that, within the scope of the appended claims, the invention may be practiced otherwise than is specifically described above.

What is claimed and desired to be secured by a Letters Patent of the United States is:

1. A method for emulating an analog video recording system comprising the steps of:
(a) converting analog data to digital signals to a predetermined digital compression format; and
(b) emulating standard analog tape functions with respect to said digital signals.

2. The method as recited in claim 1, wherein step (a) comprises:
(a) converting analog data to digital signals in MPEG-2 format.

3. The method as recited in claim 1, wherein step (b) comprises:
(b) emulating the head position of an analog recording device.

4. The method as recited in claim 1, wherein step (b) comprises:
(b) emulating a record mode of an analog recording device.

5. The method as recited in claim 1, wherein step (b) comprises:
(b) emulating a playback mode of an analog recording device.

6. The method as recited in claim 1, wherein step (b) comprises:
(b) emulating a rewind mode of an analog recording device.

7. The method as recited in claim 1, wherein step (b) comprises:
(b) emulating a fast forward mode of an analog recording device.

8. The method as recited in claim 1, wherein step (b) comprises:
(b) emulating overwriting of existing data of an analog recording device.

9. A method or replacing analog recording devices in aircraft which are configured with analog controls in the cockpit for such analog recording devices, the method comprising the steps of:
(a) removing said analog recording device;
(b) installing a digital recording device that emulates the functions of an analog recording device; and
(c) connecting said analog controls to said digital recording device.

10. A digital recording device comprising: the steps of:
an analog to digital converter for converting analog signals to digital signals;
an encoder for encoding said digital signals to a predetermined compression format defining encoded signals; and
a system for emulating one or more functions of an analog recording device with respect to said encoded signals.

11. The digital recording device recited in claim 10, wherein said system is configured to emulate a record function.

12. The digital recording device recited in claim 10, wherein said system is configured to emulate a fast forward function.

13. The digital recording device recited in claim 10, wherein said system is configured to emulate overwriting existing data.

14. The digital recording device recited in claim 10, wherein said system is configured to emulate a scan forward function.

15. The digital recording device recited in claim 10, wherein said system is configured to emulate a rewind function.

16. The digital recording device recited in claim 10, wherein said system is configured to create a compressed data file that can be played back on conventional playback devices.

17. The digital recording device recited in claim 10, wherein said encoder is an MPEG-2 encoder defining encoded output signals.

18. The digital recording device recited in claim 17, further including a playback system.

19. The digital recording device recited in claim 18, wherein said playback system includes a playback device, a digital to analog converter and a decoder.

20. The digital recording device recited in claim 18, wherein said playback system is a conventional playback system.

21. The digital recording device recited in claim 17, wherein said system causes said decoded output signals to be stored in Groups of Pictures (GOPs) having the same size.

22. The digital recording device as recited in claim 21, wherein said system includes one or more timers for keeping track of the time in a record mode and a playback mode.

23. The digital recording device as recited in claim 22, wherein the system can emulate an end of tape condition.

24. The digital recording device recited in claim 10, wherein said system is configured to emulate a scan reverse function.
